(19) United States
(12) Patent Application Publication
(10) Pub. No.: US 2021/0224596 A1
(43) Pub. Date: Jul. 22, 2021

(54) SYSTEM AND METHOD FOR IMPROVED FAKE DIGITAL CONTENT CREATION

(71) Applicant: John McDevitt, Clearwater, FL (US)

(72) Inventor: John McDevitt, Clearwater, FL (US)

(21) Appl. No.: 17/148,507

(22) Filed: Jan. 13, 2021

Related U.S. Application Data
(60) Provisional application No. 62/963,132, filed on Jan. 19, 2020.

(51) Int. Cl. G06K 9/62; G06N 20/00; G06K 9/78; G06K 9/00

(52) U.S. Cl. CPC G06K 9/6256; G06K 9/00791; G06K 9/78; G06N 20/00

(57) ABSTRACT

The described system and method include rules and requirements for the creation of fake digital content, as well as ways to create the fake digital content (including creating original fake digital content and manipulating true digital content to make fake digital content). Also, the system and method provide a means to introduce the fake digital content into a process to recognize and analyze digital content in order to train that process to identify fake digital content. Furthermore, the system and method provide and a way to collect the results of the evaluation process and feed that back into the system and method for additional cycles (if needed).

### CROSS REFERENCE TO RELATED APPLICATION

This application claims priority to U.S. Provisional Application No. 62/963,132, entitled System and Method for Improved Fake Digital Content Creation, filed on Jan. 19, 2020 the contents of which are incorporated herein by reference into the present application.

### BACKGROUND OF THE INVENTION

A wide variety of industries and companies (such as Amazon AWS ML/AI Services, IBM Watson, Microsoft AI, and Google AI Platform) are utilizing digital content analysis in areas including but not limited to autonomous vehicle navigation, voice recognition/response, natural language processing, genetic editing, process optimization, automated reasoning, thermal efficiency analysis, image recognition, medical test analysis, and video review. The industries are using a combination of machine learning (ML) and artificial intelligence (AI) processes to perform these analyses. To improve the quality of any of these analyses a large quantity of original digital content is needed. This large quantity of digital content is reviewed and analyzed by systems to learn to identify patterns and improve the quality of recognition and analysis of new digital content that is being reviewed. However, to test the quality of the digital content analysis processes fake digital content also needs to be reviewed by the processes to see if the processes identify the fake digital content as being fake (and exclude it and/or create patterns and processes to deal with fake digital content). Furthermore, to better train the systems fake digital content may be provided and identified to the system as such to allow the system to learn to differentiate between true and fake digital content.

However, a large amount of original digital content is needed for a machine learning/artificial intelligence recognition and analysis (ML/AI R&A) processes to analyze for the process to have high degree of confidence in the accuracy of recognition. For example, but not limitation, the digital image set needed for autonomous vehicle training is many millions, if not billions of images. Sets of data of this size are very difficult and very expensive to collect, store, and manage—requiring very large and expensive systems. Similarly, the size of the set of fake digital content that is needed to effectively train and test the ML/AI R&A processes are also very large. Furthermore, while actual true digital content is relatively straightforward to collect, fake digital content is much more complicated to collect or create. Fake digital content cannot be collected just by means of observation and capture of actual surroundings, by definition it cannot be just a reflection of objective reality. Appropriate fake digital content (FDC) to be most effective for training and testing it must be correctly designed to effectively train and test the ML/AI R&A processes to discriminate between true digital content (TDC) and FDC.

Due to the complexities of FDC creation, the variety of types of FDC that are needed, the specific nature of the FDC, and the volume of FDC that is needed, a robust system and method is required to enable the process of creating meaningful FDC in material volumes. Furthermore, when the ML/AI R&A process is applied to the FDC the nature of the successes or failures of the ML/AI R&A process may be understood and then that information may be fed back into the FDC system to enable more appropriate FDC to be created in order to continue to improve the ML/AI R&A processes. The nature of this feedback loop may result in requirements for different kinds of FDC (e.g., very slight differences from reality, very larger differences from reality, more noise, less noise, etc.). These specific additional requirements further increase the need for a system and method to create FDC. Furthermore, the failures of ML/AI R&A processes to correctly identify FDC provide important insights into where additional training with more TDC and/or FDC is needed.

### SUMMARY OF THE INVENTION

Accordingly, there is a need in the industry for a method and system that creates FDC according to a given rule set to provide a set of FDC in appropriate volume and nature of being fake to train and test ML/AI R&A processes. This system and method are needed to improve the overall ML/AI R&A processes in correctly identifying TDC and FDC, improving the speed of recognition, and most importantly increase the overall performance (including safety) of the system processes. Furthermore, with such life-or-death critical systems, such as, but not limited to, autonomous vehicles or medical MRI analysis it is imperative that these systems are strenuously trained and tested to ensure the safety and reliability of such systems. Even, in less critical processes the quality of the digital content analysis is needed to improve system performance and limit the unnecessary consumption of data storage, network bandwidth, analysis service resources, user time, and other resources. This described system and method would not only reduce the waste of resources, but improve the recognition systems, refining system accuracy, reliability, overall user experience, and safety.

The system and method disclosed herein provides for the creation of one or more FDC sets for use in testing digital content analysis systems. In this invention Digital Content (DC), includes but is not limited to, audio (in any digital format, e.g., aa, flac, mp3, way, wma, etc.), images (in any digital format, e.g., JPEG, TIFF, GIF, BMP, PNG, SVG, pdf, etc.), video (in any digital format, e.g., AV1, VP9, FLV, AVI, MOV, WMV, MPEG-4, MPEG-2, MPEG-5, HEVC, etc.), LIDAR, text (in any digital format, e.g., txt, asc, etc.), Virtual Reality/Augmented Reality/Mixed Reality (VR/AR/MR), visible, invisible, thermal images, medical records, seismic data, gravitational data, electromagnetic, IR, MRI, biologic, genomic, NMR, X-ray, UV, radio, or any other similar digital data in any digital format, and descriptive metadata related to or that describes any of the types of digital content, including but not limited to, DC spatiotemporal data, capture location data, capture time data, capture device identification data, capture device inclination data, capture device movement data, capture device orientation information, capture device camera data, capture device microphone data, capture device setting data, contextual data, content identification data, content labeling data, use data, preference data, trend data, transactional data, translytic data, operational data, and other similar data related to the DC and how/when/where/how/why it was captured). Furthermore, the DC may be live (truly live or near live—delayed by processing or distance to be transmitted) or pre-recorded and the live content may be truly live, or originally live and re-presented, or a combination of both. Also, the DC can be spontaneously generated or previously generated and displayed in real time (or a combination of both). Alternatively, the DC could have never been presented live and is just previously recorded or previously created. The DC may be created or captured by an individual amateur, a group of amateurs, by a professional (person or system), a group of professionals, a computer/automated system, or any combination of these. Any or all of the machine data, descriptive data, metadata about or contained in the DC may be used to identify, organize, or sort the DC. Furthermore, the data in the digital content may be unstructured, semi-structured, and/or structured. Also, DC also includes both TDC and FDC. Additionally, the system can also begin with analog content which can be converted to digital content and then the process can proceed as if it started with digital content.

In this invention original TDC includes but is not limited to any content that accurately (or as accurately as reasonably expected) reflects reality, is not FDC, and not intended to be fake, deceptive, or misrepresent reality. Please note the terms “user”, “viewer”, “listener” and “consumer” are used interchangeably, generically, and could mean any creator/capturer/consumer/requestor/reviewer of DC (TDC or FDC), creator/capturer/consumer/requestor/reviewer of any of the data from the ML/AI R&A process, and the user could be a human individual, a group of humans, an animal or animals, another computer system, or set of systems (including ML/AI R&A or other similar systems). The term computer system includes traditional general-purpose computers (minimally at least one processor and at least one storage database), quantum computers and combinations of traditional and quantum computers. The computing and computer(s) parts may be local or remote from each other (e.g., in the cloud). Additionally, the term “view” is used generically and can mean any method of consumption of the DC (e.g., read, watch, listen to, play, interface with, or otherwise experience). Furthermore, in this invention FDC, includes but is not limited to any DC that is not TDC at a given time, in a given place, to a given user. That is the FDC is for one or more reasons, by way of example but not limitation, incorrect, false, deceptive, invalid, anachronistic, adulterated, incoherent, illogical, irrational, incomplete, fabricated, exaggerated, minimized, embellished, overlapping, mis-merged, out of sequence, out of focus, occluded, pixilated, erroneous, disrupted, corrupted, degraded, distorted, blurry, vague, foggy, or containing noise, static, jitter, artifacts, compression artifacts, blocking, chop, flicker, or errors including, but not limited to, material gross errors, blunders, instrumental errors, systematic errors, random errors, operator errors, or any other condition that fails the DC from being TDC.

In this invention the term goal(s) is used broadly and may mean amongst other things, a desired result (outcome) or a desired process performance. Also, in this invention the term rule(s) is used generically (often in the simplest form being If-Then statements) and may include one, some, or all set(s) of rules including, amongst others, DC rules (inclusions, exclusions, title, content, subject matter, capture device, capture individual, date of creation, timing of creation, location of creation, angle of creation, language, duration, rating, geographic location, maximum length, minimum length, maximum number of results, minimum number of results, bit rate, DC dimensions, format, type of DC, TDC type, FDC type, error type(s), or any other parameter related to the particular DC), business rules, individualized or grouped preferences, individual or grouped, and variable randomization methodologies may be in whole, partially, or individually utilized to decide which FDC or sub set of FDC to utilize. Furthermore, these rules may act as logical engines that may organize, prioritize, include, exclude, change the likelihood, etc. of a given individual FDC item (or set of a FDC items) to be used in the analysis. The rules may be set by a user, an individual, group, a system, a computer, or a combination of any of these. The rules may be pre-established or dynamically established, or a combination of both.

A set of goals and rules related to the FDC that may provide a set of characteristics for a set of FDC is requested from the exemplary system. The system queries the FDC Library (an electronic database) to check if there is sufficient FDC to satisfy the rules and goals. If there is not, the system will then either create new original FDC and/or (depending on the rules) take existing TDC and modify it, through a variety of means to convert the TDC into FDC. Once there is a set of FDC to satisfy the rules and goals it is sent to the ML/AI R&A process. The results of the analysis performed by the ML/AI R&A process are evaluated and the resulting information is fed back to create an adjusted or updated FDC rule set (if needed). This process may not be repeated, or it may be repeated multiple times until the user is satisfied with the process or it satisfies the initial rules and requirements—meeting the goals.

The disclosed system uses the term ML/AI R&A which in this case includes machine learning and artificial intelligence research and analysis as performed by classical (traditional) general-purpose computers and may also include quantum computing methodologies or a combination of both (locally or separate, in parallel or sequence). The disclosed ML/AI R&A process may be one or more computing server(s)/processor(s) and one or more electronic database(s) that may be co-located or distributed (in the cloud) or a combination of each. Similarly, the servers, processors, and storage (database(s)) may be co-located or distributed or a combination of both. As such, the rules, the TDC library, the FDC library, the creation of original FDC, the manipulation of the TDC to create FDC, the DC (including the TDC and the FDC) analysis system, the feedback process, and if applicable the user, may each be discrete, or in various sub-sets, or collectively one.

In alternative embodiments, additional third party created Other FDC may be used and included in the FDC library. By way of example, but not limitation, Other FDC could be FDC that is supplied by other similar but separate systems. It would be possible for separate but analogous systems to be run in parallel, in series, or a combination of both to allow for higher speed and greater volume of processing such that the set of systems more effectively tests the ML/IA R&A processes.

It should be recognized that the disclosed system may be utilized to train, test, and help improve systems that analyze DC to better differentiate between TDC and FDC (including amongst other things, erroneous DC, and maliciously false DC). The evaluation of DC may be applied to a wide variety of different DC, including but not limited to, entertainment, education, information, commerce, gamming, navigation, security analysis, police investigations, crowd analysis, medical data, machine data, deep fake analysis, voice spoofs, and the like.

The disclosed example system for selecting and generating fake digital content in order to improve the recognition of fake digital content and the accuracy of a system differentiating between true digital content and fake digital content, the system includes a communicatively coupled system that contains, by way of example, but not limitation, the elements described herein and perform the described actions in a coordinated coherent fashion. There includes, at least one processor with software instructions stored thereon that, when executed by the at least one processor, configure the at least one processor to execute the software code such that; A fake digital content rules engine (101) is configured to establish at least one set of fake digital content goals and rules; at least one fake digital content engine configured to generate at least one set of fake digital content that has communicatively coupled to it; at least one electronic database containing at least one piece of true digital content and at least one processor configured to modify at least one piece of true digital content, creating fake digital content (106) by at least one of: obscuring, replacing, removing, inverting, or other similar change or manipulation to at least a portion of the true digital content such that at least one a portion of the resulting digital content set is fake digital content. The described system also includes at least one processor configured to recognize and analyze digital content (107) and it is communicatively coupled to the fake digital content engine (106) and is capable of reviewing the created fake digital content. The quality of recognition and analysis of the fake digital content is evaluated by means of at least one processor (108) as to the relative achievement of the process rules, requirements, and goals (101). The at least one rules requirements engine (101) is further configured to receive updates related to at least one historical result (108) related to the fake digital content recognition and analysis engine. Additionally, the fake digital content rules, goals, and requirements set engine (101) may additionally be configured to calculate the set of approved fake digital content based in part on at least one historical result of fake digital content recognition and analysis, if there are historical results (there do not need to be any historical results). Also, the recognition and analysis engine (107) may also be configured to receive existing fake digital content from the existing fake digital content library (if any) (103) that complies with the fake digital content rules and requirements. Furthermore, the recognition and analysis engine may further be configured to receive systematically created fake digital content from the systematic fake digital content creation engine (105) that complies with the fake digital content rules and requirements (if any).

The disclosed example method for selecting and generating fake digital content in order to improve the fake digital content recognition and the accuracy of a system differentiating between true digital content and fake digital content. The method includes a communicatively coupled process that includes the elements described herein and performs the described actions a coordinated coherent fashion. The method generates by at least one processor with software instructions stored thereon that, when executed by the at least one processor, configure the at least one processor to execute software code such that by way of example but not limitation the following occurs: At least one fake digital goals, rules, and requirements engine (205) configured to produce at least one set of fake digital content with a given set of characteristics; at least one processor with software instructions stored thereon that, when executed by the at least one processor, configure the at least one processor to establish at least one set of fake digital content rules; generate by means of, at least one fake digital content engine configured to generate at least one set of fake digital content (220). This process (220) utilizing, at least one electronic database containing at least one piece of true digital content and utilizing, at least one processor configured to modify at least one piece of true digital content, creating fake digital content by at least one of: obscuring, removing, inverting, manipulating, or replacing at least one a portion of the true digital content such that the remaining digital content is fake digital content. Then, at least one processor configured to recognize and analyze digital content (225) processes the fake digital content. The results of the recognition and analysis of the fake digital content is evaluated by means of at least one processor as to the relative achievement of the process rules and goals (230). At least one goals, rules requirements engine (205) is further configured to receive updates related to at least one historical result related to the fake digital content recognition and analysis engine (235). Additionally, the example method may also include a case where the fake digital content goals, rules and requirements set engine (205) is further configured to calculate the set of approved fake digital content based on at least one historical result of fake digital content recognition and analysis (if any). Also, the recognition and analysis engine (225) may also be configured to receive existing fake digital content from the existing fake digital content library (210) that complies with the fake digital content rules and requirements (215). Furthermore, the recognition and analysis engine (225) may further be configured to receive systematically created fake digital content from the systematic fake digital content creation engine (220) that complies with the fake digital content rules and requirements.

### BRIEF DESCRIPTION OF THE DRAWINGS

FIG. 1 illustrates a block diagram of a system to create FDC and use FDC to test ML/AI R&A processes in accordance with an exemplary embodiment.

FIG. 2 illustrates a flowchart for a method of creating FDC and using FDC to test ML/AI R&A processes in accordance with an exemplary embodiment.

FIG. 3 illustrates a block diagram of a system of creating FDC by manipulating TDC in accordance with an exemplary embodiment.

FIG. 4 illustrates an example of a traditional general purpose computer system in accordance with an exemplary embodiment.

### DETAILED DESCRIPTION

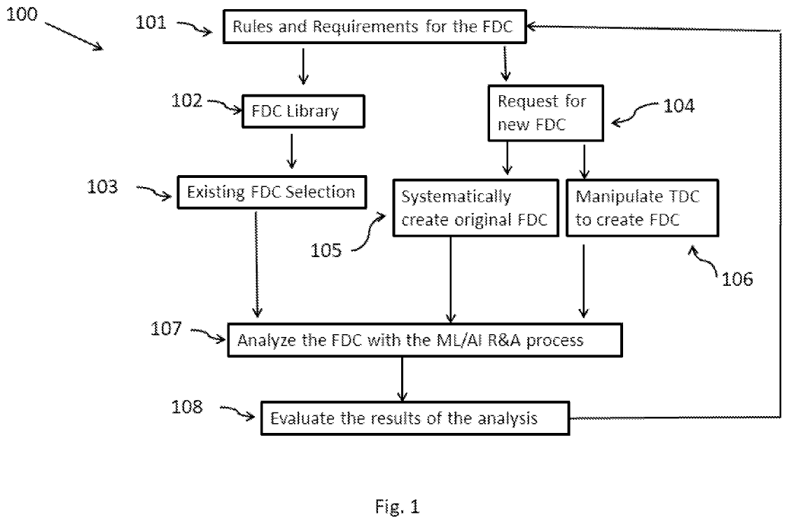

The following detailed description outlines possible embodiments of the proposed system and method disclosed herein for exemplary purposes. The system and method disclosed are in no way meant to be limited to any specific combination of hardware and software. As will be described below, the system and method disclosed herein relate to the creation and analysis of FDC. An exemplary embodiment of the environment in which the FDC is requested, created, and analyzed is illustrated in FIG. 1, which includes the components described below. It should be appreciated that each of the components are illustrated as simple block diagrams, but include the requisite hardware and software components needed to perform the specified functions as would be appreciated by one skilled in the art. For example, one or more of the components described below can include one or more computer processor units (general purpose computer(s) and/or quantum processors) configured to execute software programs stored on electronic memory/storage in order to execute the algorithms disclosed herein, and these processors and related storage may be located together or apart. Furthermore, each portion of the system is communicatively coupled allowing the parts to work in a coordinated and coherent fashion (synchronously or asynchronously)

For example, but not limitation, (100) is a basic explanatory example of the system for the creation of FDC in order to make a set of FDC more efficiently and effectively for use in testing of DC analysis systems. This system has multiple processes that are communicatively coupled together and may occur all in one location or in multiple locations (real or virtual), in series and/or in parallel. In this exemplary case the process starts with the Rules and Requirements for the FDC (101)—effectively a logic engine that contains the goal(s) of the exemplary process and the related rules and requirements needed to be met to achieve the goal(s). These rules may include, by way of example, but not limitation, a certain set (number of items) and with certain characteristics. These characteristics may cover a wide variety of things, including but not limited to, the type of DC (e.g., video, images, audio, thermal images, AR/VR/MR content, etc.), the general type of things contained in the DC (e.g., as an example but not limitation, in the case of image DC, does it contain people, or place, or vehicles, or brand logos, etc.), the technical details (commonly the metadata) of the FDC (e.g., the size, the resolution, the dimensions, color or black & white, the date of creation, etc.), and the type of fake that it is (e.g., the FDC is for one or more reasons, by way of example but not limitation, incorrect, deceptive, invalid, anachronistic, incoherent, illogical, irrational, distorted, erroneous, or any other condition that causes it to fail from being TDC).

Furthermore, in the example of FIG. 1 (100) when the request for FDC is made the FDC Library (database) (102) is queried. If there is compliant and appropriate FDC in the FDC Library (102) to satisfy the request for qualifying FDC, that FDC may be used. A FDC request includes requirements that the FDC in the FDC Library (102) has characteristics matching criteria with at least a minimum level of match. The matching of the requested FDC and the FDC contained in the FDC Library (102) occurs by means of the Existing FDC Selection (103) which acts like a logic engine processor evaluating the match. Additionally, for all FDC that minimally achieves a match, the relative quality of match is established and a ranking of the matching rules and or requirements set(s) is used to prioritize the FDC to be used. In the case where there is a set of FDC that matches the given criteria at a given quality of match a standard prioritization and/or randomization approach may be used to select and order the FDC by means of the Existing FDC Selection (103). The selected existing FDC is sent to be analyzed by the commutatively coupled ML/AI R&A Process (107). If there is not sufficient existing FDC in the FDC Library (102) to satisfy the request for FDC in accordance with the rules and requirements, additional FDC is requested by means of Request for new FDC (104).

There are two main approaches in this embodiment of creating additional FDC—truly original FDC and TDC manipulated to create FDC. Truly original FDC content may be created by means of systematically creating original FDC (105) process in accordance with the request rules. A variety of methods may be used to create this original FDC content. By way of example, but not limitation, in the case of an original FDC image, the system may create content by random colorization of individual image pixels. This results in an image that is by its nature not reflective of reality and is FDC. Further rules may be applied to this process to arrive at other embodiments, other images with different characteristics, but have the common characteristic of being compliant with the rules and requirements (101). The other main approach is to Manipulate TDC to create FDC (106) (the manipulation of TDC may be in part or in whole). This manipulation is performed in accordance with the rules and requirements to create FDC that satisfy the characteristics of the requested FDC. Once original FDC is created or TDC is manipulated to create manipulated FDC it may also be included in the FDC library (102) for use in later cycles or processes. To support the manipulation of TDC to create FDC (106) contains a library (database) of TDC that may be manipulated in a variety of ways, including but not limited to obscuring, replacing, inverting, reversing, removing, scrambling, blurring, disorder, etc. any part or portion of the TDC to create FDC. The original FDC creation process (105) may operate quickly producing a large quantity of FDC, but by its nature it is usually better suited to produce technical or machine-based errors (e.g., generalized randomized errors not based depictions of reality, but more abstract, mathematical FDC more like static or noise). Alternatively, the manipulation of TDC FDC creation process (106) is better suited to distortion of reality or deceptive FDC. Additionally, for all FDC (originally created (105) and/or manipulated (106)) that minimally achieves a match, the relative quality of match is established and a ranking of the matching rules and or requirements set(s) is used to prioritize the FDC to be used. In the case where there is a set of FDC that matches the given criteria at a given quality of match a standard prioritization and/or randomization approach may be used to select and order the FDC.

Please note, in alternative embodiments, the FDC can be real-time (e.g., live FDC), or after real-time (e.g., pre-recorded FDC), or spontaneously created FDC or any combination of these types of FDC. It should be noted that each of the FDC acquisition process may be performed systematically and automatically without user intervention, or each may also be performed with a manual user over-ride (or a combination of both). Additionally, the rules of this system (100) may be pre-set or may be dynamically adapted in real-time (continuously or periodically), and the adaptations may be based on the information that is available at that time, and also as additional information becomes available the rules may be further dynamically (continuously or periodically) adapted. These changes may be based on either or a combination of user or ML/AI R&A input.

Once sufficient FDC is assembled or created by means of one or more of the existing FDC Library, original FDC creation, and manipulation of TDC, the FDC transferred toward the ML/AL R&A process and is used to train and or test the performance of the ML/AI R&A processor (107). By example, but not limitation, in this embodiment the training and or testing is to help the ML/AI R&A process to learn what is FDC and then to successfully test that the ML/AI R&A process detects that the FDC is indeed fake, and possibly additionally identify, in what way(s) the FDC fake. Furthermore, the training and tests may deal with many aspects of FDC analysis, including but not limited to; how much FDC data is needed to train the system, how many times does the FDC need to be scanned before the FDC element is detected, can the system detect which part(s) of the FDC is TDC and what part(s) is FDC, the relative certainty of it being fake, the relative percentage of “fakeness” in the FDC, do the fake part(s) create risks to the goals of the system or can the fake aspects be safely ignored, can the system find the fake parts and replace them with true parts from other similar observations of TDC (or from logic processing).

Once the ML/AI R&A process completes its activities the results are reviewed by the Evaluation process (108). The results from the Evaluation process (108) are fed back to the Rules and Requirements (101) to help to refine and the FDC requests. This cycle may be repeated several times by this system until the initial goals are achieved. Additionally, in alternate embodiments multiples of the described system could be assembled in parallel (or in series, or a combination of both), to support higher volume and/or faster processing. Furthermore, in such an embodiment with multiple parallel systems, one may more heavily utilize the FDC library, another creates more original FDC, and another manipulate more TDC to create FDC. This specialization of portions of the process may further improve processing. Furthermore, in alternative embodiments, the storage and or processing may be centralized or decentralized that may occur in a single physical location, multiple physical locations, distributed through the cloud, or a combination of any of these. In an example embodiment, each FDC item may be stored with associative metadata to classify/characterize the FDC item. As the results and performance of the system is analyzed and improved over time resulting in achieving the goals and it may also result in more efficient use of processor resources, server resources, time and most valuably accuracy and reliability of ML/AI R&A processes. Additionally, in the example case the steps follow the above-described order, but it should be recognized that the steps can be done simultaneously, in different order, repetitively, different groups of data being processed at different times, iteratively processed, partial processing of different data sets may be completed, and others not completed, each and every process may be completed in part or in whole in alternate embodiments.

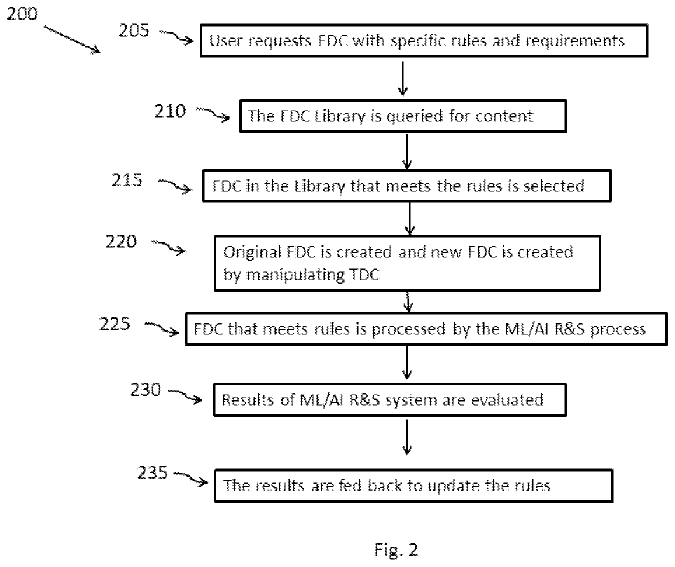

FIG. 2 illustrates a flowchart for a method (200) according to an exemplary first embodiment. In this example, a user that is testing the performance of a ML/AI R&A process requests a set of FDC items with characteristics that follow a given rule and requirement set to achieve a certain goal set (205). These rules in this embodiment, for example but not limitation, may be dealing with driving condition analysis and recognition. The related DC may all have the common characteristic of having to do with the surroundings around a car including amongst other things other vehicles and traffic patterns. The TDC may include millions of images (and image metadata elements) of vehicle movement and behavior such that the ML/AI R&A process may learn common patterns and arrive at car movement behaviors that would allow for successful collision avoidance and efficient travel. However, any given system may have systematic error (or other error) or may have the introduction of malicious data and the system needs to be able to learn which cases of images it is processing need to be recognized as erroneous (or fake) in order to avoid improper responses. To test the ML/AI R&A processes large sets of FDC need to be reviewed to both test and teach the process about what to do when faced with erroneous DC. For this to be effective, large sets of specifically erroneous FDC needs to be created for the system to review and learn from.

Furthermore, in the given embodiment, once the FDC set rules and requirements are established the library of FDC is queried (210) and applicable FDC (if any) is selected (215). It is often the case that additional FDC is needed to fulfill the requested FDC. The additional FDC (220) can be acquired in a variety of ways including but not limited to the creation of original FDC and the manipulation of TDC to create FDC. The creation of original FDC can be accomplished in a wide variety of programmatic ways. In the current embodiment an example would be creating an image of pure random FDC—similar to incoherent noise or static. This type of image is especially useful to mimic a sudden complete camera system failure. Alternatively, the manipulation of TDC to create FDC is useful to mimic a partial camera system failure or loss of DC integrity.

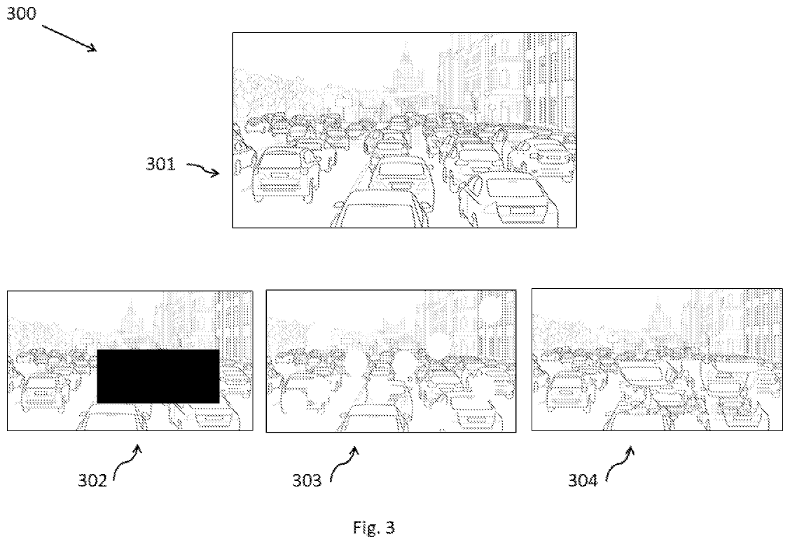

A few examples of manipulation of TDC to create FDC are shown in FIG. 3 (300). By way of example but not limitation 301 is a simple line drawing that represents an example of TDC in relation to the example embodiment of the area around a car. That TDC may be manipulated to create FDC (e.g., 106). In this example, 302 is a case where part of the TDC 301 is obscured, 303 is a case where the TDC 301 is missing part of the content, and 304 is a case where part of TDC 302 is inverted. In all of these cases the TDC has been manipulated to create FDC. Furthermore, the TDC may also be manipulated to create FDC by additional means including but not limited to, including but not limited to reversing, replacing, scrambling, blurring, disordering, etc. any part or portion of the TDC.

In the example method after sufficient FDC is obtained as established in the initial request (205) (either from the FDC library, original FDC creation, manipulation of TDC to create FDC, or a combination of any or all of these) the FDC is run through the ML/AL R&A process (225). The procedure with the FDC in the ML/AI R&A process helps to train the ML/AI R&A to learn about the nature of the FDC and after it is trained (or to evaluate the training) the ML/AI R&A may then be tested with FDC (the set of FDC for the training and the set of FDC for testing may be identical, partially separate, or completely separate, based on the rules and requirements of the process).

At this point in the exemplary method, the results of the training and or the following tests are reviewed and evaluated to see how well the ML/AI R&A process performed (230) (e.g., was the FDC correctly identified). The quality of the performance of the ML/AI R&A process with the training and/or testing FDC is fed back to the start of the method and setting the goals and requirements of the next cycle of the process (235). This process may occur only once, or it may be repeated many times depending on the overall goals, rules, requirements, and results. Furthermore, the process may be performed iteratively to further refine and improve the ML/AI R&A process allowing it to become more refined and intelligent in its ability to successfully discern FDC (and the nature of the FDC). This iterative process may be done with one or more parallel methods which allows for faster learning (or alternatively sequentially). Also, the entire process may be done in whole or in parts, continuously or periodically, and the steps may be done in this order or may be done in alternative orders to most effectively achieve the goals and rules of the process in accordance with any limitations or constraints.

In an alternative embodiment randomization may be included in the process dealing with the creation of the FDC, the choice of the FDC to be used, the training process, and the testing process. Furthermore, TDC may be included in the FDC as an additional training and testing procedure. The more extensive training and testing procedures may also include a double-blind process where neither the selecting process nor the training/testing process knows if the DC is TDC or FDC. Randomization rules may be applied each time or any time the process runs to any step or steps in the process. A variety of standard randomization approaches may be used, including but not limited to any one of the following techniques (or a combination of multiple techniques, with or without element repetition, and with or without sequencing); simple, replacement, block, permuted block, biased coin, minimization, stratified, covariate adaptive, and response adaptive. In application and testing of the various randomization techniques subject blinding may be used (in an attempt to avoid various biases including observer bias and confirmation bias, amongst others). The variety of DC that is achieved through randomization provides additional observations that may be used to further improve optimization analyses and resulting ML/AI R&A process.

Please note, this system does not require any explicit user to initiate this system. However, user information may be used to ensure that the more relevant DC is used and presented to the ML/AI R&A process such that the rules and goals are better achieved. Additionally, the improved ML/AI R&A processes may be used to create, model, run test versions, monitor, analyze, and iteratively improve any or all of the DC, TDC, and FDC sets. Furthermore, this invention may also be utilized in very different environments such as in biological evolutionary training and testing or large group training and testing where this system may be applied to review potential future states of genetic engineering (including CRISPR), organisms, and or populations.

Exemplary systems include systems; that recognizes an item (or sets of items) in source Content and identifies additional data or metadata about the identified item(s) and may recognize given items in the Content, as in U.S. Pat. Nos. 9,167,304, 9,344,774, 9,503,762, 9,681,202, 9,843,824, 10,003,833, 10,136,168, 10,327,016, 10,779,019, the navigation of video Content as in U.S. Pat. Nos. 8,717,289, 9,094,707, 9,294,556, 9,948,701, 10,270,844, sending of Content to different display devices as in U.S. Pat. Nos. 9,571,875, 9,924,215, 10,631,033, the creation of virtual 3D Content as in U.S. Pat. No. 10,356,338, and the creation of randomized groups of Content as in U.S. Pat. No. 10,740,392, the creation of combined content as in U.S. patent application Ser. No. 17/113,094, and randomized genetic editing as in U.S. patent application Ser. No. 17/121,675 the contents of which are hereby incorporated by reference.

Additionally, in an additional embodiment, the system either automatically, or in response to user control, launches an electronic shopping application enabling the user to purchase one or more of the displayed products. Exemplary applications include the electronic shopping systems disclosed in U.S. Pat. Nos. 7,752,083, 7,756,758, 8,326,692, 8,423,421, 8,768,781, 9,117,234, 9,697,549, 10,154,315, 10,231,025, 10,368,135, 9,947,034, 10,089,663, and 10,366,427, the contents of each of which are hereby incorporated by reference.

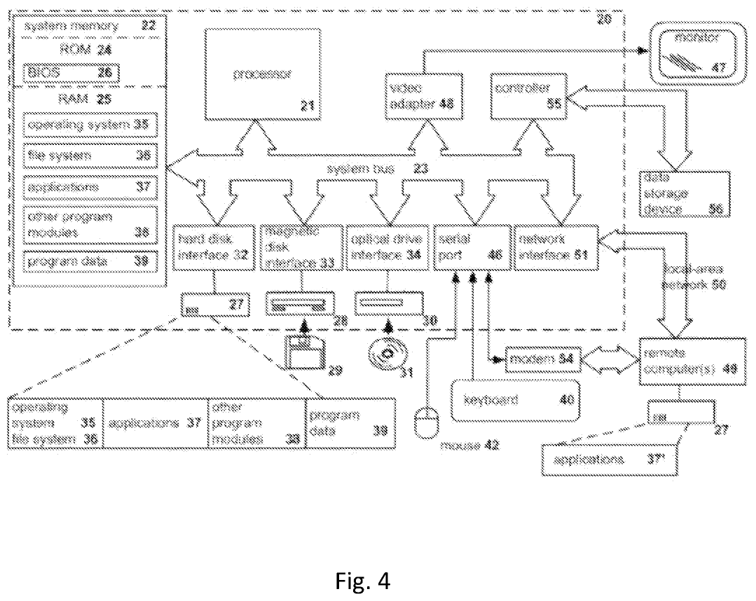

FIG. 4 illustrates an example of a general-purpose computer system (which may be a personal computer, a server, or a plurality of personal computers and servers) on which the disclosed system and method can be implemented according to an example aspect. It should be appreciated that the detailed general-purpose computer system can correspond to the system described above with respect to FIG. 1 to implement the algorithms described above. This general-purpose computer system may exist in a single physical location, with a broadly distributed structure, virtually as a subset of larger computing systems (e.g. in the computing “cloud”), or a combination of any of these.

As shown, the computer system 20 includes a central processing unit 21, a system memory 22 and a system bus 23 connecting the various system components, including the memory associated with the central processing unit 21. The central processing unit 21 can be provided to execute software code (or modules) for the one or more set of rules discussed above which can be stored and updated on the system memory 22. Additionally, the central processing unit 21 may be capable of executing traditional computing logic, quantum computing, or a combination of both. Furthermore, the system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

As noted above, the rules described above can be implemented as modules according to an exemplary aspect. As used herein, the term “module” refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20. Moreover, it is noted that any of the storage mechanisms (including data storage device 56, which may be amongst other things, physical hardware, CDN(s), or the “cloud”) can serve as the storage of the media Content, including the Available Content Library (111) described above, according to an exemplary aspect as would be appreciated to one skilled in the art.

The present disclosure provides the implementation of a system that uses a hard disk 27, a removable magnetic disk 29 and/or a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, other computer systems, and so on. Such input devices usually plug into the computer system 20 through a serial port 46, which in turn is connected to the system bus, but they can be connected in other ways, for example, with the aid of a parallel port, a game port, a universal serial bus (USB), a wired network connection, or wireless data transfer protocol. A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to operate within a network environment, using a network connection to one or more remote computers 49, which can correspond to the remote viewing devices, i.e., the IP connected device (e.g., a smartphone, tablet, personal computer, laptop, media display device, or the like). Other devices can also be present in the computer network, such as routers, network stations, peer devices or other network nodes.

Network connections 50 can form a local-area computer network (LAN), such as a wired and/or wireless network, and a wide-area computer network (WAN). Such networks are used in corporate computer networks and internal company networks, and they generally have access to the Internet. In LAN or WAN networks, the personal computer 20 is connected to the network 50 across a network adapter or network interface 51. When networks are used, the personal computer 20 can employ a modem 54 or other modules for providing communications with a wide-area computer network such as the Internet or the cloud. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for selecting and generating fake digital content in order to improve the fake digital content recognition and the accuracy of a system differentiating between true digital content and fake digital content, the system comprising:
at least one processor with software instructions stored thereon that, when executed by the at least one processor, configure the at least one processor to execute:
a fake digital content rules engine configured to establish at least one set of fake digital content rules;
at least one fake digital content engine configured to generate at least one set of fake digital content that has communicatively coupled;
at least one electronic database containing at least one piece of true digital content;
at least one processor configured to modify at least one piece of true digital content, creating fake digital content by at least one of:
obscuring at least one a portion of the true digital content such that the remaining digital content is fake digital content;
removing at least one a portion of the true digital content such that the remaining digital content is fake digital content;
inverting at least one a portion of the true digital content such that the remaining digital content is fake digital content;
replacing at least one a portion of the true digital content such that the remaining digital content is fake digital content;
at least one processor configured to recognize and analyze digital content is communicatively coupled to the fake digital content engine to review the fake digital content;
wherein the recognition and analysis of the fake digital content is evaluated by mean of at least one processor as to the relative achievement of the process rules and goals;
wherein at least one rules requirements engine is further configured to:
receive updates related to at least one historical result related to the fake digital content recognition and analysis engine.

2. The system according to claim 1, wherein the fake digital content rules and requirements set engine is further configured to calculate the set of approved fake digital content based on at least one historical result of fake digital content recognition and analysis.

3. The system according to claim 1, wherein the recognition and analysis engine is further configured to receive existing fake digital content from the existing fake digital content library that complies with the fake digital content rules and requirements.

4. The system according to claim 1, wherein the recognition and analysis engine is further configured to receive systematically created fake digital content from the systematic fake digital content creation engine that complies with the fake digital content rules and requirements.

5. A method for selecting and generating fake digital content in order to improve the fake digital content recognition and the accuracy of a system differentiating between true digital content and fake digital content, the method comprising:
generating by at least one processor with software instructions stored thereon that, when executed by the at least one processor, configure the at least one processor to execute:
generating by at least one fake digital rules and requirements engine configured to produce at least one set of fake digital content characteristics based at least one set of fake digital content;
generating by at least one processor with software instructions stored thereon that, when executed by the at least one processor, configure the at least one processor to execute:
causing a fake digital content rules and regulations engine configured to establish at least one set of fake digital content rules;
generating, by means of, at least one fake digital content engine configured to generate at least one set of fake digital content;
utilizing, at least one electronic database containing at least one piece of true digital content;
utilizing, at least one processor configured to modify at least one piece of true digital content, creating fake digital content by at least one of:
obscuring, removing, inverting, or replacing at least one a portion of the true digital content such that the remaining digital content is fake digital content;
applying at least one processor configured to recognize and analyze digital content to the fake digital content engine to review the fake digital content;
wherein the recognition and analysis of the fake digital content is evaluated by mean of at least one processor as to the relative achievement of the process rules and goals;
wherein at least one rules requirements engine is further configured to:
receive updates related to at least one historical result related to the fake digital content recognition and analysis engine.

6. The method according to claim 5, wherein the fake digital content rules and requirements set engine is further configured to calculate the set of approved fake digital content based on at least one historical result of fake digital content recognition and analysis.

7. The method according to claim 5, wherein the recognition and analysis engine is further configured to receive existing fake digital content from the existing fake digital content library that complies with the fake digital content rules and requirements.

8. The method according to claim 5, wherein the recognition and analysis engine is further configured to receive systematically created fake digital content from the systematic fake digital content creation engine that complies with the fake digital content rules and requirements.
